(19) United States
(12) Patent Application Publication
(10) Pub. No.: US 2007/0280356 A1
(43) Pub. Date: Dec. 6, 2007

(54) Method For Video Coding Conversion And Video Coding Conversion Device

(75) Inventors: Jun Zhang, Shenzhen (CN); Sinan Zeng, Shenzhen (CN); Tong Jin, Shenzhen (CN); Zhixin Qiao, Shenzhen (CN); Yuhui Luo, Shenzhen (CN); Yuniliang Guo, Shenzhen (CN)

Correspondence Address: HARNESS, DICKEY & PIERCE, P.L.C., P.O. BOX 828, BLOOMFIELD HILLS, MI, 48303, US

(73) Assignee: Huawei Technologies Co., Ltd., Shenzhen, Guangdong (CN)

(21) Appl. No.: 11/547,038

(22) PCT Filed: Dec. 2, 2005
(86) PCT No.: PCT/CN05/02073

§ 371 Date: Aug. 20, 2007

(30) Foreign Application Priority Data
Dec. 29, 2004 (CN) 200410102681.9

(51) Int. Cl. H04B 1/66

(52) U.S. Cl. 375/240.16; 375/E07.092

(57) ABSTRACT

The present invention discloses a method of video coding conversion, which includes: decoding a video frame of the first coding mode into an image of standard intermediate format while determining whether the video frame is a reference frame or prediction frame and recording the recognition result; coding the image of standard intermediate format into a video frame of the second coding mode. The present invention also discloses a video coding conversion device using the method. By using the method and device for video coding conversion in accordance with the present invention, it can be implemented to recode the images based on the types of the video frames of the original coding mode during video coding conversion so as to avoid image errors caused by recoding large numbers of prediction frames of the original coding mode into reference frames of the new coding mode, therefore the video image quality after recoding is greatly improved.

### FIELD OF THE TECHNOLOGY

The present invention relates to video coding technique. More particularly, the invention relates to a method for video coding conversion and video coding conversion device.

### BACKGROUND OF THE INVENTION

Along with the increasing maturation of The Third Generation (3G) mobile communication technique, more and more well-established functions are being supported, besides the challenge from within the 3G technology itself, commercial 3G networks are facing the challenge of inter-working with various other existing networks. Among the existing networks, packet networks are seeing fast development and traditional networks are being replaced by new packet networks gradually, thus it is a key point at present to implement the inter-working between 3G networks and the existing packet networks. Since the multimedia service is an outstanding feature of 3G, in which video service is the most popular, all commercial 3G networks at present provide video service. However, since the coding format of media stream transmitted in 3G communication networks is different from that in packet communication networks, media stream conversion must be performed at the integrating point between a 3G network and a packet network, and the device for this conversion is called a gateway. A gateway for implementing media stream conversion of video service is called Video Inter-working Gateway (VIG). As an example shown in FIG. 1, VIG is located between a 3G network and a packet network of H.323. The video image transmitted from a 3G network terminal to a H.323 terminal is coded into video frames, and then transferred to VIG through Radio Network Controller (RNC) and Gateway Mobile Switching Center (GMSC) in the 3G network successively. VIG converts the received video frames into video frames of H.323 network format and transmits the converted video frames to H.323 terminal through Internet Protocol (IP) network.

Therefore, when user terminals of two different types of networks adopt different coding formats, coding conversion device is needed as a bridge between the two networks for conversion of different coding formats so as to guarantee the inter-working between the two networks. The most common conversion is that from MPEG-4 video coding format of 3G network to H263 video coding format of H.323 network. Furthermore, since bandwidths of different networks may be different, for example, maximum video channel bandwidth of a 3G terminal device is 64 k while that of H.323 network may be rather large, adaptation of different bandwidths is required even with the same coding format. In this case, bandwidth conversion of video coding is needed.

The principle of video coding is hereinafter described. Since video signals incorporate large amounts of information, they will occupy large bandwidth if directly transmitted in the network, thus video signals are usually compressed before transmitted in the network. The basic principle of video coding is to remove redundancy information in the image, which is typically implemented by the following two methods:

Method 1: removing redundant information in the image through image transformation and image quantization. Since the human visual organ is insensitive to high-frequency signal, removal of high-frequency component of the image signal can reduce amount of information.

Method 2: removing redundant information between images through prediction. Because two adjacent video frames are usually continuous and most information of the two image frames are basically the same with only a small amount of the information that has changed, it is only necessary to transfer the changed information between the two image frames, thus greatly reducing the data to be transferred.

A video coder usually outputs the frames in a sequence as shown in FIG. 2. A coded frame obtained by method 1 is called I frame, which reflects basic information of the frame and can be directly decoded into a frame of image, so I frame is also called reference frame. A coded frame obtained by method 2 is called P frame, whose information is obtained on the basis of previous frame of image and the decoding thereof needs the information of the previous frame, so P frame is also called prediction frame. Since P frame is obtained by predicting based on the previous frame, error accumulation will occur due to existence of predictive error, and image quality will become worse and worse with the error accumulating. Therefore, the coder needs to randomly generate some I frames to resynchronize the image.

As shown in FIG. 3, during the video coding conversion at a gateway, supposing that Network A uses A coding format and Network B uses B coding format, the video frame transmitted from Network A to Network B is converted from A coding format into B coding format at VIG. Coding conversion unit in VIG usually needs to decode the video frames of A coding format and convert it into images of standard intermediate format, and then encode the images of standard intermediate format into video frames of B coding format. The converting procedure may comprise the following three steps:

Step 1: receives the video frame from Network A;

Step 2: decodes the received video frame into image of standard intermediate format and stores it in the buffer;

Step 3: encodes the image of standard intermediate format stored in the buffer into video frame of Network B format and outputs it to Network B.

During the conversion between the video coding format of H.263 and that of MPEG-4, VIG gateway starts the decoder and coder respectively for independent decoding and coding, namely, the decoder and coder are two independent components. Decoder decodes the video frames from Network A into images of standard intermediate format, which are then inputted into the coder, coded into video frames of Network B format and outputted to Network B. Coder codes the images of standard intermediate format into I frames or P frames according to the setting. Since the coder and decoder operate separately in the whole coding conversion procedure, the coder does not know which images of standard intermediate format outputted by the decoder correspond to I frame and which images of standard intermediate format correspond to P frame, so the coder will code the received images of standard intermediate format into I frames or P frames randomly. In this way, I frame of original coding mode may be converted into I frame or P frame of new coding mode, so may be P frame.

As a result of the above described procedure, a problem arises that the quality of images restored at Network B terminal becomes worse. The reason is: I frames are the reference frames of the image and subsequent P frames are all obtained based on I frames, thus there exist certain errors in the image decoded from P frames. Since P frames are much more than I frames, it is of higher probability that P frames of original coding mode be converted into I frames of new coding mode, consequently most of I frames of new coding mode are converted from P frames of original coding mode, namely there are more ineffective I frames than effective ones. As a result, a lot of reference images with error exist after re-coding, which leads to error accumulation in subsequent image prediction. The image quality will be even worse especially when there are fewer I frames. This problem also exists when bandwidth adaptation is performed at a conversion device.

In a word, as a result of the conversion device, during the conversion from one coding format to another, the received video frames need to be decoded first and then encoded again according to required bandwidth and coding format. However, the conversion method in the prior art will inevitably bring certain damage to image quality as well as impact on user's visual effect.

### SUMMARY OF THE INVENTION

The present invention provides a method for video coding conversion and a video code conversion device, while a video frame of original coding format is re-coded into that of a new coding format, the video frame is recognized as a reference frame or a prediction frame of the original coding format and then is re-coded based on the recognition result.

The technical solution in accordance with this invention is as follows:

A method for video coding conversion, used for converting video frames of the first coding mode into video frames of the second coding mode, including:

decoding a video frame of the first coding mode into an image of standard intermediate format, simultaneously determining whether the video frame is a reference frame or prediction frame, and then recording the recognition result;

coding the image of standard intermediate format into a video frame of the second coding mode based on the recorded recognition result.

The reference frame is a video frame obtained by removing the redundant space information within an image during the coding procedure; and the prediction frame is a video frame obtained by removing redundant information among images during the coding procedure.

The recording the recognition result includes: making a distinctive record of whether the video frame is a reference frame or a prediction frame.

The recording the recognition results includes: recording the recognition result of each video frame in a frame information index in order.

The coding the image of standard intermediate format into a video frame of the second coding mode based on the recorded recognition result includes: if the video frame is a reference frame, coding the image of standard intermediate format into a reference frame of the second coding mode; if the video frame is a prediction frame, coding the image of standard intermediate format into a prediction frame of the second coding mode.

Or the coding the image of standard intermediate format into a video frame of the second coding mode based on the recorded recognition result includes: if the video frame is a reference frame, coding the image of standard intermediate format into a reference frame of the second coding mode; if the video frame is a prediction frame, coding the image of standard intermediate format into a prediction frame or a reference frame of the second coding mode.

Or the coding the image of standard intermediate format into a video frame of the second coding mode based on the recorded recognition result includes: if the video frame is a prediction frame, coding the image of standard intermediate format into a prediction frame of the second coding mode; if the video frame is a reference frame, coding the image of standard intermediate format into a reference frame or a prediction frame of the second coding mode.

The first coding mode and second coding mode are coding formats of different video coding formats; or the first coding mode and second coding mode are coding formats of the same video coding format but of different coding bandwidths.

The video coding format is H261, H263, H264 or MPEG-4 coding format.

A video coding conversion device, comprising:

a decoder for decoding the video frame of the first coding mode into an image of standard intermediate format;

a coder for coding an image of standard intermediate format into a video frame of the second coding mode; and

a frame recognizer for recognizing whether a video frame of the first coding mode is a reference frame or prediction frame and outputting the recognition result to the coder;

the coder encodes the image of standard intermediate format into a reference frame or prediction frame of the second coding mode based on the recognition result from the frame recognizer.

The decoder further includes a buffer for storing images of standard intermediate format and a buffer for storing the recognition result.

A video coding conversion device, comprising: a decoder for decoding the video frame of the first coding mode into an image of standard intermediate format, and a coder for coding an image of standard intermediate format into a video frame of the second coding mode;

The decoder includes:

a decoding unit for decoding the video frame of the first coding mode into an image of standard intermediate format and outputting the image of standard intermediate format to the coder; and

a frame recognizing unit for recognizing whether a video frame of the first coding mode is a reference frame or prediction frame and outputting the recognition result to the coder;

the coder encodes the image of standard intermediate format into a reference frame or prediction frame of the second coding mode based on the recognition result of the frame recognizing unit.

In the above video coding conversion device, the coder codes the images of standard intermediate format decoded from the reference frames and the prediction frames of the first coding mode into the reference frames and the prediction frames of the second coding mode, respectively; or codes the images of standard intermediate format decoded from the reference frames of the first coding mode into the reference frames of the second coding mode, and codes the images of standard intermediate format decoded from the prediction frames of the first coding mode into the reference frames or the prediction frames of the second coding mode; or codes the images of standard intermediate format decoded from the prediction frames of the first coding mode into the prediction frames of the second coding mode, and codes the images of standard intermediate format decoded from the reference frames of the first coding mode into the reference frames or the prediction frames of the second coding mode.

The first coding mode and second coding mode are coding modes with different video coding formats; or the first coding mode and second coding mode are coding modes with the same video coding format but different coding bandwidths.

The video coding format is H261, H263, H264 or MPEG-4 coding format.

A decoder used for decoding video frames of a coding mode, comprising:

a decoding unit for decoding video frames of the coding mode into images of standard intermediate format and outputting images of this standard intermediate format; and

a frame recognizing unit for recognizing whether the video frame of the coding mode is a reference frame or prediction frame and outputting the recognition result.

It can be seen from the above technical solution that, by using the method of video coding conversion and video coding conversion device in accordance with the present invention, it is possible to recognize reference frames and prediction frames of the original coding mode during video coding conversion and recode the frames based on the recognition result.

According to one aspect of the present invention, by recoding the reference frames and prediction frames of the original coding mode into the reference frames and prediction frames of the new coding mode, respectively, it is guaranteed that all reference frames of the original coding mode be converted into reference frames of the new coding format while prediction frames of the original coding mode not be converted into reference frames of the new coding format. As a result, the image after coding conversion is of optimal quality.

According to another aspect of the present invention, by recoding the reference frames of the original coding mode into the reference frames of the new coding mode, and recoding the prediction frames of the original coding mode into the reference frames or prediction frames of the new coding mode, it is guaranteed that all reference frames of the original coding mode be converted into reference frames of the new coding mode, thus increasing the probability of effective reference frames of the new coding mode. As a result, the image quality after coding conversion is greatly improved.

According to yet another aspect of the present invention, by recoding the prediction frames of the original coding mode into the prediction frames of the new coding mode, and recoding the reference frames of the original coding mode into the reference frames or prediction frames of the new coding mode, it is guaranteed that the prediction frame of the original coding mode not be converted into the reference frame of the new coding mode, thus increasing the probability of converting the reference frame of the original coding mode into the reference frame of the new coding mode. As a result, the image quality after coding conversion is greatly improved.

No matter which one of the above-mentioned schemes is adopted, image errors caused by large numbers of prediction frames of the original coding mode being recoded into the reference frames of the new coding mode as in the prior art can be avoided to a certain extent, thus making the quality of recoded video image greatly improved.

### BRIEF DESCRIPTION OF THE DRAWINGS

FIG. 1 is a schematic diagram illustrating the location of Video Inter-working Gateway (VIG) in the network.

FIG. 2 is a schematic diagram illustrating the output of video frames.

FIG. 3 is a schematic diagram illustrating the configuration of an existing video coding conversion device.

FIG. 4a is a schematic diagram illustrating the configuration of the video coding conversion device in accordance with one embodiment of the present invention.

FIG. 4b is a schematic diagram illustrating the configuration of the video coding conversion device in accordance with another embodiment of the present invention.

FIG. 5 is a flowchart illustrating the method for video coding conversion in accordance with an embodiment of the present invention.

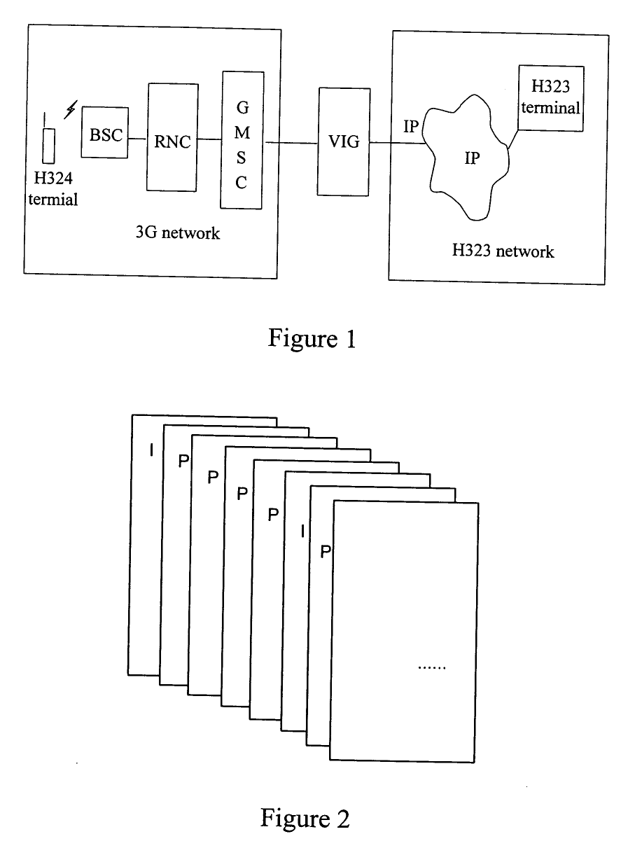

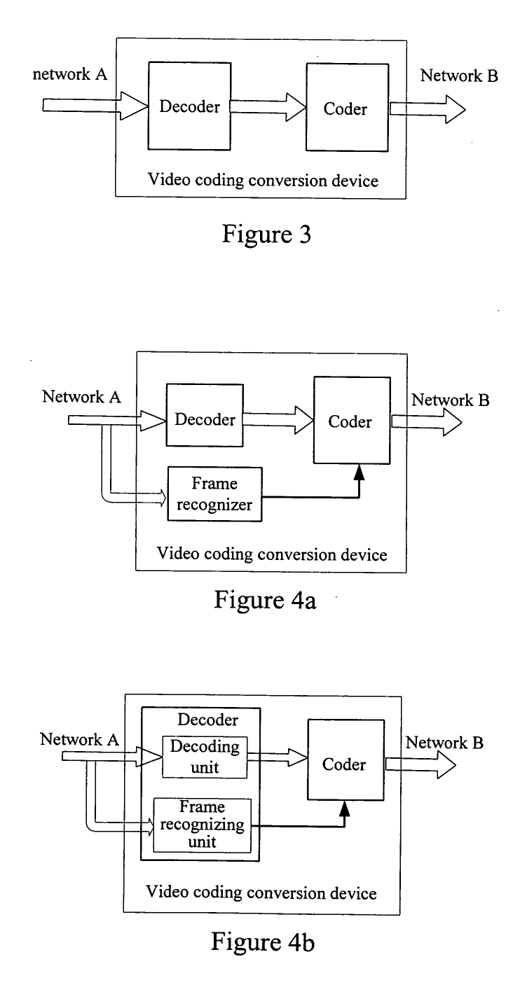

### DETAILED DESCRIPTION OF THE INVENTION

To make the object, technical schemes and advantages of the present invention clearer, the present invention will be further described in detail hereinafter with reference to the accompanying drawings and specific embodiments.

The key for implementing the present invention is to recognize whether the video frame is an I frame or P frame when decoding a video frame of the first coding mode into an image of standard intermediate format, record the recognition result, and then encode this image of standard intermediate format into the frame of the second coding mode based on the recognition result.

FIG. 4a is a schematic diagram illustrating the video coding conversion device in accordance with one embodiment of the present invention. As shown in FIG. 4a, the video coding device of the present embodiment comprises a decoder, a frame recognizer and a coder. Supposing that the video coding device of the present embodiment is used to perform coding conversion upon video frames transmitted between network A and network B, then the video frame from network A is inputted into the decoder and frame recognizer respectively, wherein the decoder decodes the video frame from network A into an image of standard intermediate format while the frame recognizer recognizes whether the video frame is an I frame or P frame and records the recognition result; the decoder outputs the image of standard intermediate format to the coder and the frame recognizer outputs the recognition result to the coder; the coder encodes the image of standard intermediate format based on the recognition result from frame recognizer and then outputs the recoded video frame to network B.

FIG. 4b is a schematic diagram illustrating the video coding conversion device in accordance with another embodiment of the present invention. As shown in FIG. 4b, the video coding device of the present embodiment comprises a decoder and a coder, wherein the decoder comprises a decoding unit and a frame recognizing unit. Still supposing that the video coding device of the present embodiment is used to perform coding conversion upon video frames transmitted between network A and network B, then the video frame from network A is inputted into the decoder, wherein the decoding unit of the decoder decodes the video frame from network A into an image of standard intermediate format while the frame recognizing unit recognizes whether the video frame is an I frame or P frame and records the recognition result; the decoding unit outputs the image of standard intermediate format to the coder and the frame recognizng unit outputs the recognition result to the coder; the coder codes the image of standard intermediate format based on the recognition result from the frame recognizing unit and then outputs the recoded video frame to network B.

The video coding conversion devices of the above two embodiments can be used for conversion between two video coding formats, in another word, for converting a video frame of one coding format into that of another coding format. The video coding conversion devices can also be used for conversion between two video coding bandwidths, in another word, for converting a video frame of one coding format into that of the same coding format but of a different coding bandwidth.

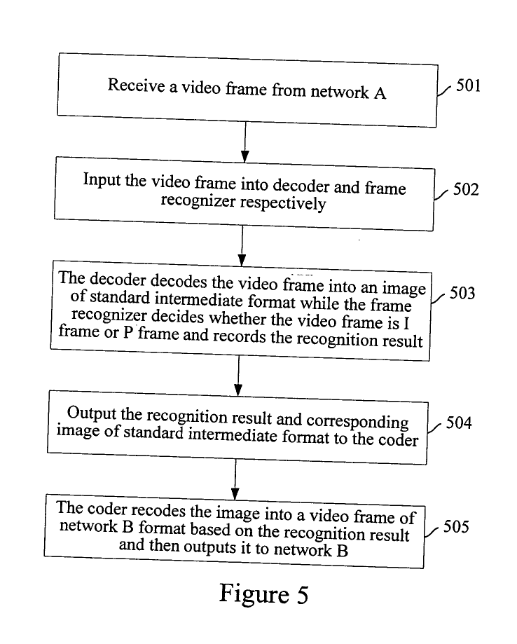

FIG. 5 is a flowchart illustrating the method for video coding conversion of the present invention. In accordance with this method, coding conversion upon video frames transmitted between network A and network B is performed by employing the video coding conversion device shown in FIG. 4a. As shown in FIG. 5, the present embodiment comprises the following steps:

Step 501: the video coding conversion device receives a video frame from network A;

Step 502: input the video frame into the decoder and frame recognizer respectively;

Step 503: the decoder decodes the video frame into an image of standard intermediate format while the frame recognizer recognizes whether this video frame is I frame or P frame and records the recognition information according to the recognition result;

There is information saved in the frame head of a video frame indicating whether this frame is an I frame or P frame, so the frame recognizer can determine whether this video is I frame or P frame by reading this information from the frame head. There are many methods for recording the recognition result, for instance, if this video frame is recognized as an I frame, the recognition result of this video frame is recorded as 1; if this video frame is recognized as a P frame, the recognition result of this video frame is recorded as 0. It is also possible to identify only all the images decoded from I frames or all the images decoded from non-I frames. No matter which identifying mode is chosen, the final purpose is to identify all images decoded from I frames and select the corresponding recoding mode.

Step 504: store the recognition result and image of standard intermediate format in buffer and establish the corresponding relationship between the recognition result and the image;

There are many ways for establishing the corresponding relationship between the recognition result and image of standard intermediate format, e.g. establishing a frame information index list for intermediate-format images of each set of video frames and storing the recognition results of each video frame in the original order of the video frames. There are various ways for storing and outputting recognition results, wherein the common way is to store the recognition results and images of standard intermediate format in two separate buffers which are both readable by the coder.

Step 505: the coder reads the images of standard intermediate format in order, recodes these images of standard intermediate format into video frames of the format of network B and then outputs them to Network B;

Before recoding each image of standard intermediate format, the coder reads the recognition result corresponding to the image stored in the frame information index list, then recodes the image based on the recognition result and outputs the recoded image to network B. Specifically, there are several implementing ways as follows:

(1) Recode the image of standard intermediate format corresponding to I frame into I frame, and recode the image of standard intermediate format corresponding to P frame into P frame. In this way, I frame and P frame in the format of network A are coded into I frame and P frame in the format of network B, respectively, to acquire optimal image quality after the coding. This is the most preferred mode of the present invention.

(2) Recode the image of standard intermediate format corresponding to I frame into I frame, and recode the image of standard intermediate format corresponding to P frame into P frame or I frame. In this way, since all I frames of the original coding mode are converted into I frames of the new coding mode, there are sufficient effective I-frame images among recoded video frames, thus guaranteeing still good image quality after the coding.

(3) Recode the image of standard intermediate format corresponding to P frame into P frame, and recode the image of standard intermediate format corresponding to I frame into I frame or P frame. In this way, it is guaranteed that P frames of the original coding mode are not converted into I frames of the new coding mode, and all I frames of the new coding mode are converted from I frames of the original coding mode, thus guaranteeing good image quality after the coding to a certain extent.

The present invention can be applied to video coding conversion among formats H261/H263/MPEG4/H264, or bandwidth adaptation of the same coding mode, but is not confined to the conversion of these video-coding formats.

Video image quality can be improved by applying the method and device of the present invention. Practical system tests show that the image quality of the system after the image coding conversion and bandwidth adaptation in accordance with the present technical scheme can be greatly improved.

To meet the needs of specific situations, the method and device according to the present invention can be properly modified in specific implementations. It should be understood that specific embodiments of the present invention described here are just for the purpose of demonstration, and not used to limit the protection scope of the present invention.

1. A method for video coding conversion, used for converting video frames of the first coding mode into video frames of the second coding mode, comprising:
decoding a video frame of the first coding mode into an image of standard intermediate format, determining whether the video frame is a reference frame or prediction frame, and recording the recognition result;
coding the image of standard intermediate format into a video frame of the second coding mode based on the recorded recognition result.

2. The method according to claim 1, wherein the reference frame is a video frame obtained by removing redundant space information within an image during the coding procedure;
the prediction frame is a video frame obtained by removing redundant information among images during the coding procedure.

3. The method according to claim 1, wherein the recording the recognition result comprises: making a distinctive recording of each video frame as a reference frame or as a prediction frame.

4. The method according to claim 1, wherein the recording the recognition result comprises: recording the recognition result of each video frame in a frame information index list in order.

5. The method according to claim 1, wherein the coding the image of standard intermediate format into a video frame of the second coding mode based on the recorded recognition result comprises: if the video frame is a reference frame, coding the image of standard intermediate format into a reference frame of the second coding mode; if the video frame is a prediction frame, coding the image of standard intermediate format into a prediction frame of the second coding mode.

6. The method according to claim 1, wherein the coding the image of standard intermediate format into a video frame of the second coding mode based on the recorded recognition result comprises: if the video frame is a reference frame, coding the image of standard intermediate format into a reference frame of the second coding mode; if the video frame is a prediction frame, coding the image of standard intermediate format into a prediction frame or a reference frame of the second coding mode.

7. The method according to claim 1, wherein the coding the image of standard intermediate format into a video frame of the second coding mode based on the recorded recognition result comprises: if the video frame is a prediction frame, coding the image of standard intermediate format into a prediction frame of the second coding mode; if the video frame is a reference frame, coding the image of standard intermediate format into a reference frame or a prediction frame of the second coding mode.

8. The method according to claim 1, wherein the first coding mode and second coding mode are coding modes of different video coding formats; or the first coding mode and second coding mode are coding modes of the same video coding format but of different coding bandwidths.

9. The method according to claim 8, wherein the video coding format is H261, H263, H264 or MPEG-4 coding format.

10. A video coding conversion device, comprising:
a decoder for decoding a video frame of the first coding mode into an image of standard intermediate format;
a coder for coding the image of standard intermediate format into a video frame of the second coding mode; and
a frame recognizer for recognizing the video frame of the first coding mode as a reference frame or a prediction frame and outputting the recognition result to the coder;
the coder encoding the image of standard intermediate format into a reference frame or a prediction frame of the second coding mode based on the recognition result from the frame recognizer.

11. The video coding conversion device according to claim 10, wherein the coder encodes the images of standard intermediate format decoded from the reference frames and the prediction frames of the first coding mode into the reference frames and the prediction frames of the second coding mode respectively; or encodes the images of standard intermediate format decoded from the reference frames of the first coding mode into the reference frames of the second coding mode, and encodes the images of standard intermediate format decoded from the prediction frames of the first coding mode into the reference frames or the prediction frames of the second coding mode; or encodes the images of standard intermediate format decoded from the prediction frames of the first coding mode into the prediction frames of the second coding mode, and encodes the images of standard intermediate format decoded from the reference frames of the first coding mode into the reference frames or the prediction frames of the second coding mode.

12. The video coding conversion device according to claim 10, wherein the decoder further comprises a buffer for storing images of standard intermediate format and a buffer for storing the recognition result.

13. The video coding conversion device according to claim 10, wherein the first coding mode and second coding mode are coding modes with different video coding formats; or the first coding mode and second coding mode are coding modes with the same video coding format but different coding bandwidths.

14. The video coding conversion device according to claim 13, wherein the video coding format is H261, H263, H264 or MPEG-4 coding format.

15. A video coding conversion device, comprising:
a decoder for decoding the video frame of the first coding mode into an image of standard intermediate format;
a coder for coding the image of standard intermediate format into a video frame of the second coding mode;
wherein the decoder comprises:
a decoding unit for decoding the video frame of the first coding mode into an image of standard intermediate format and outputting the image of standard intermediate format to the coder; and
a frame recognizing unit for recognizing the video frame of the first coding mode as a reference frame or a prediction frame and outputting the recognition result to the coder;
the coder encoding the image of standard intermediate format into a reference frame or prediction frame of the second coding mode based on the recognition result of the frame recognizing unit.

16. The video coding conversion device according to claim 15, wherein the coder encodes the images of standard intermediate format decoded from the reference frames and the prediction frames of the first coding mode into the reference frames and the prediction frames of the second coding mode respectively; or encodes the images of standard intermediate format decoded from the reference frames of the first coding mode into the reference frames of the second coding mode, and encodes the images of standard intermediate format decoded from the prediction frames of the first coding mode into the reference frames or the prediction frames of the second coding mode; or encodes the images of standard intermediate format decoded from the prediction frames of the first coding mode into the prediction frames of the second coding mode, and encodes the images of standard intermediate format decoded from the reference frames of the first coding mode into the reference frames or the prediction frames of the second coding mode.

17. The video coding conversion device according to claim 15, wherein the first coding mode and second coding mode are coding modes with different video coding formats; or the first coding mode and second coding mode are coding modes with the same video coding format but different coding bandwidths.

18. The video coding conversion device according to claim 17, wherein the video coding format is H261, H263, H264 or MPEG-4 coding format.

19. A decoder for decoding video frames of a certain coding mode, comprising:
a decoding unit for decoding video frames of the coding mode into images of standard intermediate format and outputting images of this standard intermediate format; and
a frame recognizing unit for recognizing a video frame of the coding mode as a reference frame or a prediction frame and outputting the recognition result.
